(19) United States
(12) Patent Application Publication
(10) Pub. No.: US 2023/0219827 A1
(43) Pub. Date: Jul. 13, 2023

(54) ELECTRODE ACTIVE MATERIALS AND PROCESSES TO MAKE THEM

(71) Applicants: BASF SE, Ludwigshafen am Rhein (DE); KARLSRUHER INSTITUT FUR TECHNOLOGIE, Karlsruhe (DE)

(72) Inventors: Matteo BIANCHINI, Ludwigshagen am Rhein (DE); Pascal HARTMANN, Ludwigshagen am Rhein (DE); Torsten BREZESINSKI, Eggenstein-Leopoldshafen (DE); Simon SCHWEIDLER, Eggenstein-Leopoldshafen (DE)

(21) Appl. No.: 17/996,955

(22) PCT Filed: Apr. 28, 2021
(86) PCT No.: PCT/EP2021/061173

§ 371 Date: Oct. 24, 2022

(30) Foreign Application Priority Data
May 6, 2020 (EP) 20173224.5

(51) Int. Cl. C01G 53/00; H01M 10/0525

(52) U.S. Cl. CPC C01G 53/50; H01M 10/0525; C01P 2004/50; C01P 2004/51; C01P 2004/61; C01P 2006/12; C01P 2006/40

(57) ABSTRACT

Process for making a particulate lithiated transition metal oxide comprising the steps of: (a) Providing a particulate transition metal precursor comprising Ni, (b) mixing said precursor with at least one compound of lithium and at least one processing additive selected from NaCl, KCl, CuCl₂, B₂O₃, MoO₃, Bi₂O₃, Na₂SO₄, and K₂SO₄ in an amount of from 0.1 to 5% by weight, referring to the entire mixture obtained in step (b), (c) thermally treating the mixture obtained according to step (b) in at least two steps, (c1) at 300 to 500° C. under an atmosphere that may comprise oxygen, (c2) at 650 to 850° C. under an atmosphere of oxygen.

The present invention is directed towards a process for making a particulate lithiated transition metal oxide comprising the steps of:

(a) providing a particulate transition metal precursor comprising Ni,

(b) mixing said precursor
(b1) with at least one compound of lithium, and,
(b2) before or after step (c1), with at least one processing additive selected from NaCl, KCl, CuCl₂, B₂O₃, MoO₃, Bi₂O₃, Na₂SO₄, and K₂SO₄ in an amount of from 0.1 to 5% by weight, preferably from 0.5 to 5% by weight, referring to sum of precursor and compound of lithium,

(c) thermally treating the mixture obtained according to step (b) in at least two steps,
(c1) at 300 to 500° C. under an atmosphere that may comprise oxygen,
(c2) at 650 to 850° C. under an atmosphere of oxygen.

Lithiated transition metal oxides are currently being used as electrode active materials for lithium-ion batteries. Extensive research and developmental work have been performed in the past years to improve properties like charge density, specific energy, but also other properties like the reduced cycle life and capacity loss that may adversely affect the lifetime or applicability of a lithium-ion battery. Additional effort has been made to improve manufacturing methods.

In a typical process for making cathode materials for lithium-ion batteries, first a so-called precursor is being formed by co-precipitating the transition metals as carbonates, oxides or preferably as hydroxides that may or may not be basic, for example oxyhydroxides. The precursor is then mixed with a source of lithium such as, but not limited to LiOH, Li₂O or Li₂CO₃ and calcined (fired) at high temperatures. Lithium salt(s) can be employed as hydrate(s) or in dehydrated form. The calcination—or firing—often also referred to as thermal treatment or heat treatment of the precursor—is usually carried out at temperatures in the range of from 600 to 1,000° C. During the thermal treatment a solid-state reaction takes place, and the electrode active material is formed. The thermal treatment is performed in the heating zone of an oven or kiln.

A typical class of cathode active materials delivering high energy density contains a high amount of Ni (Ni-rich), for example at least 80 mol-%, referring to the content of non-lithium metals. This however results in limited cycle life due to several instability problems of the cathodes in the charged state. A leading cause of degradation in batteries containing Ni-rich cathode materials is mechanical particles fracture due to large volume changes during delithiation. The breaking of primary and secondary particles within a battery can be effectively probed in real time by acoustic emission, a sensitive technique that detects the sound waves emitted by the breaking particles.

It was therefore an objective of the present invention to provide cathode active materials with high cycling stability, which may be detected that they do not suffer of significant particles fracture during cycling and hence they are promising candidates for improved cycling stability. It was further an objective of the present invention to provide a process for the manufacture of cathode active materials with high cycling stability.

Accordingly, the process defined at the outset has been found, hereinafter also referred to as inventive process or process according to the present invention. The inventive process will be described in more detail below.

The inventive process comprises the following steps (a) and (b) and (c), hereinafter also referred to as step (a) and step (b) and step (c) or briefly as (a) or (b) or (c), respectively:

In step (a), a particulate precursor is provided that comprises nickel. Said precursor may be selected from carbonates, oxides, hydroxides and oxyhydroxide that comprise nickel. Preferably, such particulate precursor is a hydroxide or oxyhydroxide of TM wherein at least 80 mol-% of TM is nickel.

In one embodiment of the present invention, said particulate precursor comprises nickel and at least one metal selected from Co and Mn, and, optionally, at least one further metal selected from Ti, Zr, Mo, W, Al, Mg, Nb, and Ta, and preferably, at least 80 mol-% of the metal content of the precursor is nickel.

Said precursor may contain traces of further metal ions, for example traces of ubiquitous metals such as sodium, calcium or zinc, as impurities but such traces will be neglected in the description of the present invention. Traces in this context will mean amounts of 0.05 mol-% or less, referring to the total metal content of said precursor.

In one embodiment of the present invention the particulate transition metal precursor is selected from hydroxides, carbonates, oxyhydroxides and oxides of TM wherein TM is a combination of metals according to general formula (I)

(NiₐCo_{b}Mn_{c})_{1-d}M_{d} (I)

with

a being in the range of from 0.8 to 0.95, preferably 0.85 to 0.91

b being in the range of from zero to 0.1, preferably zero to 0.05

c being in the range of from zero to 0.1, preferably 0.02 to 0.05, and

d being in the range of from zero to 0.1,

M is selected from Mg, Al, Ti, Zr, Mo, W, Al, Nb, and Ta,

wherein at least one of the variables b and c is greater than zero, and

a+b+c=1.

The precursor is in particulate form. In one embodiment of the present invention, the mean particle diameter (D50) of the precursor is in the range of from 4 to 15 μm, preferably 6 to 15 μm, more preferably 7 to 12 μm. The mean particle diameter (D50) in the context of the present invention refers to the median of the volume-based particle diameter, as can be determined, for example, by light scattering, and it refers to the secondary particle diameter.

In one embodiment of the present invention, the particle shape of the secondary particles of the precursor is deviating from ideal spherical shape, for example rather comparable to potatoes. In one embodiment of the present invention, the aspect ratio of the secondary particles is in the range of 1.2 to 3.5, preferably from 1.8 to 2.8.

In one embodiment of the present invention the specific surface area (BET) of the precursor is in the range of from 1 to 10 m²/g, preferably 2 to 10 m²/g, determined by nitrogen adsorption, for example in accordance with to DIN-ISO 9277:2003-05.

In one embodiment of the present invention, the precursor may have a particle diameter distribution span in the range of from 0.5 to 0.9, the span being defined as [(D90)-(D10)] divided by (D50), all being determined by LASER analysis. In another embodiment of the present invention, the precursor may have a particle diameter distribution span in the range of from 1.1 to 1.8.

In step (b1), the resultant precursor is mixed with one compound of lithium, hereinafter also referred to as “source of lithium”.

Examples of sources of lithium are Li₂O, LiNO₃, LiOH, Li₂O₂, Li₂CO₃, each water-free or as hydrate, if applicable, for example LiOH—H₂O. Preferred are LiOH, Li₂O, and Li₂O₂. More preferred source of lithium is lithium hydroxide.

Such source of lithium is preferable in particulate form, for example with an average diameter (D50) in the range of from 3 to 10 μm, preferably from 5 to 9 μm.

In one embodiment of the present invention the amount of compound of lithium is selected in a way that the molar ratio of lithium versus the molar metal content of the precursor is in the range of from 1:1 to 1.1:1, preferably from 1.02:1 to 1.05:1.

In step (b2), at least one processing additive selected from NaCl, KCl, CuCl₂, B₂O₃, MoO₃, Bi₂O₃, Na₂SO₄, and K₂SO₄ is added in an amount of from 0.1 to 5% by weight, preferably from 0.5 to 5% by weight, referring to sum of precursor and compound of lithium. MoO₃, NaCl and KCl, and mixtures of at least two thereof are preferred, for example a eutectic mixture of NaCl and KCl.

In one embodiment of the present invention, said processing additive has an average particle diameter (D50) in the range of from 1 to 50 μm, preferably from 2 to 10 μm.

The order of addition of precursor, source of lithium and processing additive is not critical. In one embodiment of the present invention, first compound of lithium and processing additive are mixed and then added to the precursor. In such embodiments, steps (b1) and (b2) are performed simultaneously.

In another embodiment of the present invention, step (b1) is performed first and, subsequently, step (b2) before subjecting the resultant mixture to step (c1).

In another embodiment of the present invention, (b2) is performed after step (c1).

In one embodiment of the present invention, the amount of the processing additive is in the range of from 0.05 to 5% by weight, referring to sum of precursor and compound of lithium, preferred are 0.1 to 2.5% by weight.

Examples of suitable apparatuses for performing step (b) are tumbler mixers, high-shear mixers, plough-share mixers and free fall mixers. On laboratory scale, mortars with pestles and ball mills are feasible as well.

In one embodiment of the present invention, mixing in step (b) is performed over a period of 1 minute to 10 hours, preferably 5 minutes to 1 hour.

In one embodiment of the present invention, mixing in step (b) is performed without external heating.

In one embodiment of the present invention, no dopant is added in step (b).

In a special embodiment of the present invention, in step (b) an oxide, hydroxide or oxyhydroxide of Mg, Al, Ti, Zr, Mo, W, Co, Mn, Al, Nb, and Ta or a combination of at least two of the aforementioned is added, preferably of Al, Ti, Zr or W, hereinafter also referred to as dopant.

Such dopant is selected from oxides, hydroxides and oxyhydroxides of Mg, Ti, Zr, Mo, W, Co, Mn, Nb, and Ta and especially of Al. Lithium titanate is also a possible source of titanium. Examples of dopants are TiO₂ selected from rutile and anatase, anatase being preferred, furthermore TiO₂-aq, basic titania such as TiO(OH)₂, furthermore Li₄Ti₅O₁₂, ZrO₂, Zr(OH)₄, ZrO₂-aq, Li₂ZrO₃, basic zirconia such as ZrO(OH)₂, furthermore CoO, CO₃O₄, Co(OH)₂, MnO, Mn₂O₃, Mn₃O₄, MnO₂, Mn(OH)₂, MoO₂, MoO₃, MgO, Mg(OH)₂, Mg(NO₃)₂, Ta₂O₅, Nb₂O₅, Nb₂O₃, furthermore WO₃, Li₂WO₄, Al(OH)₃, Al₂O₃, Al₂O₃-aq, and AlOOH. Preferred are Al compounds such as Al(OH)₃, α-Al₂O₃, γ-Al₂O₃, Al₂O₃-aq, and AlOOH. Even more preferred dopants are Al₂O₃ selected from α-Al₂O₃, γ-Al₂O₃, and most preferred is γ-Al₂O₃.

In one embodiment of the present invention such dopant may have a specific surface area (BET) in the range of from 1 to 200 m²/g, preferably from 50 to 150 m²/g. The specific surface area (BET) may be determined by nitrogen adsorption, for example according to DIN-ISO 9277:2003-05.

In one embodiment of the present invention, such dopant is nanocrystalline. Preferably, the average crystallite diameter of the dopant is 100 nm at most, preferably 50 nm at most and even more preferably 15 nm at most. The minimum diameter may be 4 nm.

In one embodiment of the present invention, such dopant(s) is/are a particulate material with an average diameter (D50) in the range of from 1 to 10 μm, preferably 2 to 4 μm. The dopant(s) is/are usually in the form of agglomerates. Its particle diameter refers to the diameter of said agglomerates.

In a preferred embodiment, dopant(s) are applied in an amount of up to 1.5 mol-% (referred to total metal content of the respective precursor), preferably 0.1 up to 0.5 mol-%.

Although it is possible to add an organic solvent, for example glycerol or glycol, or water in step (b) and perform the mixing in a ball-mill it is preferred to perform step (b) in the dry state, that is without addition of water or of an organic solvent.

A mixture is obtained from step (b).

Step (c) includes subjecting the mixture from step (b) to thermal treatment at at least two different temperatures:

(c1) at 300 to 500° C., preferably 400 to 485° C. under an atmosphere that may comprise oxygen, and

(c2) at 650 to 850° C., preferably 700 to 825° C. under an atmosphere of oxygen.

In a preferred embodiment of the present invention, step (c1) is performed at a temperature in the range of from 400 to 485° C. and step (c2) is performed at a temperature in the range of from 725 to 825° C.

The atmosphere of oxygen in step (c2) may be pure oxygen or oxygen diluted with low amounts of a non-oxidizing gas, for example up to 5 vol-% of nitrogen or argon, determined at normal conditions.

The atmosphere in step (c1) may be oxidizing, for example air or mixtures of air and a non-oxidizing gas such as nitrogen or argon. It is preferred that the atmosphere in step (c1) is oxidizing. Even more preferably, the atmosphere in step (c1) is pure oxygen.

Although steps (c1) and (c2) may be performed in different vessels, it is preferred to perform them in the same and to change the temperature and preferably the atmosphere when transitioning from step (c1) to (c2).

In one embodiment of the present invention, step (c) is performed in a roller hearth kiln, a pusher kiln or a rotary kiln or a combination of at least two of the aforementioned. Rotary kilns have the advantage of a very good homogenization of the material made therein. In roller hearth kilns and in pusher kilns, different reaction conditions with respect to different steps may be set quite easily. In lab scale trials, box-type and tubular furnaces and split tube furnaces are feasible as well.

In one embodiment of the present invention, step (c) of the present invention is performed under a forced flow of gas, for example air, oxygen and oxygen-enriched air. Such stream of gas may be termed a forced gas flow. Such stream of gas may have a specific flow rate in the range of from 0.5 to 15 m³/(h-kg), referring to electrode active material according to general formula Li₁₊ₓTM₁₋ₓO₂. The volume is determined under normal conditions: 298 Kelvin and 1 atmosphere. Said forced flow of gas is useful for removal of gaseous cleavage products such as water.

In one embodiment of the present invention, step (c) has a duration in the range of from two to 30 hours. Preferred are 10 to 24 hours. The cooling time is neglected in this context.

In one embodiment of the present invention, step (c1) has a duration in the range of from one to 15 hours. Preferred are 3 to 10 hours.

In one embodiment of the present invention, step (c2) has a duration in the range of from one to 15 hours. Preferred are 5 to 12 hours. The cooling time is neglected in this context.

After thermal treatment in accordance to step (c), the electrode active material so obtained is cooled down before further processing. Additional—optional—steps before further processing the resultant electrode active materials are sieving and de-agglomeration steps.

By the inventive process, electrode active materials with excellent properties are obtained, especially with respect to crack resistance and cycling stability.

In one embodiment of the present invention, after step (c), the electrode active material is washed with an alcohol, for example with ethanol or methanol, or with water, then filtered and dried. Said washing may be supported by stirring or ball-milling.

A further aspect of the present invention is directed to electrode active materials, hereinafter also referred to as inventive electrode active materials or as inventive cathode active materials. Inventive cathode active materials may be synthesized according to the inventive process. Inventive electrode active materials are described in more detail below.

Inventive electrode active materials are in particulate form, and they correspond to the general formula Li₁₊ₓTM₁₋ₓO₂, wherein TM is a combination of Ni and at least one transition metal selected from Co and Mn, and, optionally, at least one further metal selected from Ti, Zr, Mo, W, Al, Mg, Nb, and Ta, and x is in the range of from zero to 0.2, wherein the average diameter (D50) of its primary particles is in the range of from 2 to 15 μm and wherein the acoustic activity in the frequency range of from 350 to 700 kHz is lower than 150 cumulative hits/cycle during the first cycle. In this context, an acoustic signal is deemed being a hit if at least two counts exceeding 27 dB are recorded.

Inventive electrode active materials are in particulate form. In one embodiment of the present invention, the mean particle diameter (D50) of inventive electrode active materials is in the range of from 2 to 15 μm, preferably from 5 to 10 μm. The mean particle diameter (D50) in the context of the present invention refers to the median of the volume-based particle diameter, as can be determined, for example, by light scattering, and it refers to the secondary particle diameter.

In one embodiment of the present invention, the particle shape of the secondary particles of the precursor is deviating from ideal spherical shape, for example rather comparable to potatoes. In one embodiment of the present invention, the aspect ratio of the secondary particles is in the range of from 1.2 to 3.5, preferred from 1.8 to 2.8.

In one embodiment of the present invention the specific surface area (BET) of inventive electrode active materials is in the range of from 0.1 to 1.5 m²/g, determined by nitrogen adsorption, for example in accordance with to DIN-ISO 9277:2003-05.

In one embodiment of the present invention, inventive electrode active materials may have a particle diameter distribution span in the range of from 0.5 to 0.9, the span being defined as [(D90)-(D10)] divided by (D50), all being determined by LASER analysis. In another embodiment of the present invention, inventive electrode active materials may have a particle diameter distribution span in the range of from 1.1 to 1.8.

In one embodiment of the present invention, secondary particles of inventive electrode active materials are composed of 2 to 35 primary particles on average, as determined by assessment of SEM (Scanning Electron Microscopy).

A further aspect of the present invention refers to electrodes comprising at least one electrode active material according to the present invention. They are particularly useful for lithium ion batteries. Lithium ion batteries comprising at least one electrode according to the present invention exhibit a good cycling behavior/stability. Electrodes comprising at least one electrode active material according to the present invention are hereinafter also referred to as inventive cathodes or cathodes according to the present invention.

Specifically, inventive cathodes contain
(A) at least one inventive electrode active material,
(B) carbon in electrically conductive form,
(C) a binder material, also referred to as binders or binders (C), and, preferably,
(D) a current collector.

In a preferred embodiment, inventive cathodes contain
(A) 80 to 98% by weight inventive electrode active material,
(B) 1 to 17% by weight of carbon,
(C) 1 to 15% by weight of binder material, percentages referring to the sum of (A), (B) and (C).

Cathodes according to the present invention can comprise further components. They can comprise a current collector, such as, but not limited to, an aluminum foil. They can further comprise conductive carbon and a binder.

Cathodes according to the present invention contain carbon in electrically conductive modification, in brief also referred to as carbon (B). Carbon (B) can be selected from soot, active carbon, carbon nanotubes, graphene, and graphite, and from combinations of at least two of the aforementioned.

Suitable binders (C) are preferably selected from organic (co)polymers. Suitable (co)polymers, i.e. homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol-% of copolymerized ethylene and up to 50 mole-% of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is not only understood to mean homo-polypropylene, but also copolymers of propylene which comprise at least 50 mol-% of copolymerized propylene and up to 50 mol-% of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder (C) is polybutadiene.

Other suitable binders (C) are selected from polyethylene oxide (PEO), cellulose, carboxymethylcellulose, polyimides and polyvinyl alcohol.

In one embodiment of the present invention, binder (C) is selected from those (co)polymers which have an average molecular weight M_{w} in the range from 50,000 to 1,000,000 g/mol, preferably from 50,000 to 500,000 g/mol.

Binder (C) may be cross-linked or non-cross-linked (co)polymers.

In a particularly preferred embodiment of the present invention, binder (C) is selected from halogenated (co)polymers, especially from fluorinated (co)polymers. Halogenated or fluorinated (co)polymers are understood to mean those (co)polymers which comprise at least one (co)polymerized (co)monomer which has at least one halogen atom or at least one fluorine atom per molecule, more preferably at least two halogen atoms or at least two fluorine atoms per molecule. Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders (C) are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

Inventive cathodes may comprise 1 to 15% by weight of binder(s), referring to electrode active material. In other embodiments, inventive cathodes may comprise 0.1 up to less than 1% by weight of binder(s).

A further aspect of the present invention is a battery, containing at least one cathode comprising inventive electrode active material, carbon, and binder, at least one anode, and at least one electrolyte.

Embodiments of inventive cathodes have been described above in detail.

Said anode may contain at least one anode active material, such as carbon (graphite), TiO₂, lithium titanium oxide, silicon or tin. Said anode may additionally contain a current collector, for example a metal foil such as a copper foil.

Said electrolyte may comprise at least one non-aqueous solvent, at least one electrolyte salt and, optionally, additives.

Non-aqueous solvents for electrolytes can be liquid or solid at room temperature and is preferably selected from among polymers, cyclic or acyclic ethers, cyclic and acyclic acetals and cyclic or acyclic organic carbonates.

Examples of suitable polymers are, in particular, polyalkylene glycols, preferably poly-C₁-C₄-alkylene glycols and polyethylene glycols. Polyethylene glycols can here comprise up to 20 mol-% of one or more C₁-C₄-alkylene glycols. Polyalkylene glycols are preferably polyalkylene glycols having two methyl or ethyl end caps.

The molecular weight M_{w} of suitable polyalkylene glycols and in particular suitable polyethylene glycols can be at least 400 g/mol.

The molecular weight M_{w} of suitable polyalkylene glycols and in particular suitable polyethylene glycols can be up to 5,000,000 g/mol, preferably up to 2,000,000 g/mol.

Examples of suitable acyclic ethers are, for example, diisopropyl ether, di-n-butyl ether, 1,2-dimethoxyethane, 1,2-diethoxyethane, with preference being given to 1,2-dimethoxyethane.

Examples of suitable cyclic ethers are tetrahydrofuran and 1,4-dioxane.

Examples of suitable acyclic acetals are, for example, dimethoxymethane, diethoxymethane, 1,1-dimethoxyethane and 1,1-diethoxyethane.

Examples of suitable cyclic acetals are 1,3-dioxane and in particular 1,3-dioxolane.

Examples of suitable acyclic organic carbonates are dimethyl carbonate, ethyl methyl carbonate and diethyl carbonate.

Examples of suitable cyclic organic carbonates are compounds according to the general formulae (II) and (III)

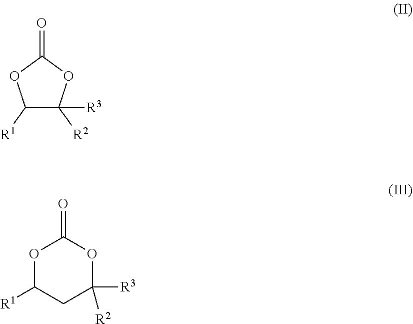

where R¹, R² and R³ can be identical or different and are selected from among hydrogen and C₁-C₄-alkyl, for example methyl, ethyl, n-propyl, isopropyl, n-butyl, isobutyl, sec-butyl and tert-butyl, with R² and R³ preferably not both being tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (IV).

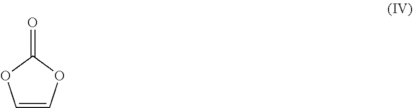

The solvent or solvents is/are preferably used in the water-free state, i.e. with a water content in the range of from 1 ppm to 0.1% by weight, which can be determined, for example, by Karl-Fischer titration.

Electrolyte (C) further comprises at least one electrolyte salt. Suitable electrolyte salts are, in particular, lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range of from 1 to 20, LiN(SO₂F)₂, Li₂SiF₆, LiSbF₆, LiAlCl₄ and salts of the general formula (CₙF₂ₙ₊₁SO₂)ₜYLi, where m is defined as follows:

t=1, when Y is selected from among oxygen and sulfur,

t=2, when Y is selected from among nitrogen and phosphorus, and

t=3, when Y is selected from among carbon and silicon.

Preferred electrolyte salts are selected from among LiC(CF₃SO₂)₃, LiN(CF₃SO₂)₂, LiPF₄, LiBF₄, LiClO₄, with particular preference being given to LiPF₆ and LiN(CF₃SO₂)₂.

In an embodiment of the present invention, batteries according to the invention comprise one or more separators by means of which the electrodes are mechanically separated. Suitable separators are polymer films, in particular porous polymer films, which are unreactive toward lithium metal. Particularly suitable materials for separators are polyolefins, in particular film-forming porous polyethylene and film-forming porous polypropylene.

Separators composed of polyolefin, in particular polyethylene or polypropylene, can have a porosity in the range of from 35 to 45%. Suitable pore diameters are, for example, in the range from 30 to 500 nm.

In another embodiment of the present invention, separators can be selected from among PET nonwovens filled with inorganic particles. Such separators can have porosities in the range of from 40 to 55%. Suitable pore diameters are, for example, in the range of from 80 to 750 nm.

Batteries according to the invention further comprise a housing which can have any shape, for example cuboidal or the shape of a cylindrical disk or a cylindrical can. In one variant, a metal foil configured as a pouch is used as housing.

Batteries according to the invention display a good discharge behavior, for example at low temperatures (zero ° C. or below, for example down to −10° C. or even less), a very good discharge and cycling behavior.

Batteries according to the invention can comprise two or more electrochemical cells that combined with one another, for example can be connected in series or connected in parallel. Connection in series is preferred. In batteries according to the present invention, at least one of the electrochemical cells contains at least one cathode according to the invention. Preferably, in electrochemical cells according to the present invention, the majority of the electrochemical cells contains a cathode according to the present invention. Even more preferably, in batteries according to the present invention all the electrochemical cells contain cathodes according to the present invention.

The present invention further provides for the use of batteries according to the invention in appliances, in particular in mobile appliances. Examples of mobile appliances are vehicles, for example automobiles, bicycles, aircraft or water vehicles such as boats or ships. Other examples of mobile appliances are those which move manually, for example computers, especially laptops, telephones or electric hand tools, for example in the building sector, especially drills, battery-powered screwdrivers or battery-powered staplers.

The present invention is further illustrated by the following working examples.

General: rpm: revolutions per minute

I. Manufacture of Inventive Cathode Active Materials

I.1 Manufacture of a Precursor TM-OH.1, Step (a.1)

A stirred tank reactor was charged with an aqueous solution of 49 g of ammonium sulfate per kg of water. The solution was tempered to 55° C. and a pH value of 12 was adjusted by adding an aqueous sodium hydroxide solution.

The co-precipitation reaction was started by simultaneously feeding an aqueous transition metal sulfate solution and aqueous sodium hydroxide solution at a flow rate ratio of 1.8, and a total flow rate resulting in a residence time of 8 hours. The transition metal solution contained the sulfates of Ni, Co and Mn at a molar ratio of 8.3:1.2:0.5 and a total transition metal concentration of 1.65 mol/kg. The aqueous sodium hydroxide solution contained 25 wt. % sodium hydroxide solution and 25 wt. % ammonia solution in a weight ratio of 6. The pH value was kept at 12 by the separate feed of an aqueous sodium hydroxide solution. Beginning with the commencement of all feeds, mother liquor was removed continuously. After 33 hours all feed flows were stopped. The mixed transition metal (TM) oxyhydroxide precursor TM-OH.1 was obtained by filtration of the resulting suspension, washing with distilled water, drying at 120° C. in air and sieving. Average particle diameter (D50): 10 μm.

I.2 Manufacture of a Cathode Active Material

I.2.1 Manufacture of a Mixture, (b.1)

In a planetary mixer, precursor TM-OH.1 was mixed with LiOH monohydrate with a Li/(Ni+Co+Mn) molar ratio of 1.02 and with 1% by weight—referring to the sum of lithium hydroxide and precursor, of a eutectic mixture of NaCl/KCl (1:1 by mol of KCl/NaCl).

I.2.2 Calcination

In each case, heating rates and cooling rates were 3° C./min.

Step (c1.1): The mixture obtained from 1.2.1 was heated to 450° C. over a period of time of 6 hours in an atmosphere of dry air in a muffle furnace. Then, it was cooled to ambient temperature. A pre-calcined mix was obtained.

Step (c2.1): The pre-calcined mix from step (c1.1) was heated to 750° C. over a period of time of 12 hours in an atmosphere of pure oxygen in a muffle furnace. A cathode active material CAM.1 was obtained.

CAM.1 was then subjected to ball-milling with ethanol (1 ml ethanol per g CAM. 1) at 60 rpm, followed by filtration. Drying at 100° C. in vacuo for 8 hours furnished the finished CAM. 1.

For the manufacture of comparative electrode active material C-CAM.2, the above procedure was repeated but without addition of NaCl/KCl.

II. Testing of Cathode Active Material

II.1 Electrode Manufacture, General Procedure

Positive electrode: PVDF binder (Solef® 5130) was dissolved in NMP (Merck) to produce a 7.5 wt. % solution. For electrode preparation, binder solution (3 wt. %) and carbon black (Super C65, 3 wt. %) were suspended in NMP. After mixing using a planetary centrifugal mixer (ARE-250, Thinky Corp.; Japan), inventive CAM (or comparative CAM) (94 wt. %) was added and the suspension was mixed again to obtain a lump-free slurry. The solid content of the slurry was adjusted to 61%. The slurry was coated onto Al foil using a KTF-S roll-to-roll coater (Mathis AG). Prior to use, all electrodes were calendared. The thickness of cathode material was 100 μm, corresponding to 6.5 mg/cm². All electrodes were dried at 105° C. for 7 hours before battery assembly.

II.2 Electrolyte Manufacture

A base electrolyte composition was prepared containing 1 M LiPF₆ in 3:7 by weight ethylene carbonate and ethyl methyl carbonate (EL base 1).

II.3 Test Cell Manufacture

Coin-type half-cells (20 mm in diameter and 3.2 mm in thickness) comprising a cathode prepared as described under II.1 and lithium metal as working and counter electrode, respectively, were assembled and sealed in an Ar-filled glove box. In addition, the cathode and anode and a separator were superposed in order of cathode/separator/Li foil to produce a coin half-cell. Thereafter, 0.15 mL of the EL base 1, which is described above (II.2), were introduced into the coin cell.

III. Evaluation of Cell Performance

Evaluation of Coin Half-Cell Performance

Cell performance were evaluated using the produced coin-type half-cell battery. For the battery performances, initial capacity and reaction resistance of cell were measured.

Cycling data were recorded at 25° C. using a MACCOR Inc. battery cycler. For ten initial cycles, cells were galvanostatically charged to 4.3 V vs Li⁺/Li, followed by 15 min of potentiostatic charging (or a shorter period if the charging current dropped below C/20), and discharged to 3.0 V vs Li⁺/Li at a rate of C/10 (1 C=225 mA/g_{CAM}). For 100 additional cycles, the charging and discharging rates were set to C/4 and C/2, respectively, and the length of the potentiostatic step at 4.3 V vs Li⁺/Li was set to 10 min. The results are summarized in Table 1.

TABLE 1
Acoustic tests and electrochemical testing
of inventive cathode active materials

| | Acoustic activity | Capacity 1^{st} | Capacity |
|---|---|---|---|
| | (Cumulative hits | discharge | retention after |
| Material | after 1^{st} cycle) | (mA · h/g) | 100 cycles |
| Comparative CAM.0 | 330 | 248/220 | 33% |
| Inventive CAM.1 | 105 | 238/190 | 57% |

Acoustic Emission measurement setup: AE instrumentation consists of a sensor, in-line preamplifier, and data acquisition system (USB AE Node, MISTRAS Group, Inc.). To detect characteristic AE events, a differential wideband sensor with operating frequency range of 125-1000 kHz (MISTRAS Group, Inc.) was fixed using silicone grease to the coin cells on the cathode side. The entire construction was placed inside a dense foam box to decrease background noise from the laboratory. For all experiments, a preamp gain, analog filter, and sampling rate of 40 dB, 20-1000 kHz and 5 MSPS, respectively, were used. AE was recorded when a hit exceeded a threshold of 27 dB. In addition, the peak definition time, hit definition time, and hit lockout time were set to 100, 200, and 200 μs, respectively. The recorded AE signals were processed with AEwin for USB software (MISTRAS Group, Inc.). Signals of less than 2 counts or lower than 100 kHz were eliminated. For the calculation of hit rate, the cumulated (measured) time-dependent AE signals were interpolated to an acquisition time with an interval of 10 s, differentiated, and smoothed using a second order polynomial and 20 points per window.

When measuring one electrochemical cycle of the CAM with the setup previously described, the acoustic activity in the frequency range of 350-700 kHz was found of 50 hits during the first cycle, i.e. belonging to the definition of a silent CAM.

1-12. (canceled)

13. A process for making a particulate lithiated transition metal oxide comprising the steps of:
(a) providing a particulate transition metal precursor comprising Ni, wherein the particulate precursor is a hydroxide or oxyhydroxide of TM and wherein at least 80 mol-% of TM is nickel;
(b) mixing said precursor, (b1) with at least one compound of lithium, and, (b2) before or after step (c1), with at least one processing additive selected from NaCl, KCl, CuCl₂, B₂O₃, MoO₃, Bi₂O₃, Na₂SO₄, and K₂SO₄ in an amount of from 0.1 to 5% by weight, referring to sum of precursor and compound of lithium, and
(c) thermally treating the mixture obtained according to step (b) in at least two steps, (c1) at 300° C. to 500° C. under an atmosphere that may comprise oxygen, and (c2) at 650° C. to 850° C. under an atmosphere of oxygen.

14. The process according to claim 13, wherein the compound of lithium is selected from Li₂O, LiOH, Li₂O₂, Li₂CO₃, and LiHCO₃.

15. The process according to claim 13, wherein the particulate mixed transition metal precursor comprises nickel and at least one metal selected from Co and Mn, and, optionally, at least one further metal selected from Ti, Zr, Mo, W, Al, Mg, Nb, and Ta.

16. The process according to claim 13, wherein the particulate transition metal precursor is selected from hydroxides, carbonates, oxyhydroxides and oxides of TM wherein TM is a combination of metals according to general formula (I)
(NiₐCO_{b}Mn_{c})_{1-d}M_{d} (I)
with
a ranging from 0.8 to 0.95,
b ranging from zero to 0.1,
c ranging from zero to 0.1, and
d ranging of from zero to 0.1,
M is selected from Mg, Al, Ti, Zr, Mo, W, Al, Nb, and Ta,
wherein at least one of the variables b and c is greater than zero, and
a+b+c=1.

17. The process according to claim 13, wherein step (c) is performed in a roller hearth kiln, in a rotary kiln, in a pusher kiln, in a vertical kiln, or in a pendulum kiln.

18. The process according to claim 13, wherein the processing additive has an average particle diameter (D50) ranging from 1 μm to 50 μm.

19. The process according to claim 13, wherein the processing additive of step (b) is added to the mixture during step (c2).

20. The process according to claim 13, wherein step (c) is performed in air, oxygen enriched air, or oxygen atmosphere.

21. A particulate electrode active material according to general formula Li₁₊ₓTM₁₋ₓO₂, wherein TM is a combination of Ni and at least one transition metal selected from Co and Mn, and, optionally, at least one further metal selected from Ti, Zr, Mo, W, Al, Mg, Nb, and Ta, and x ranges from zero to 0.2, wherein at least 80 mol of TM is nickel, wherein the average diameter (D50) of its primary particles ranges from 2 μm to 15 μm, and wherein an acoustic activity in the frequency range of from 350 kHz to 700 kHz is lower than 150 cumulative hits/cycle during the first cycle.

22. The particulate electrode active material according to claim 21, wherein its secondary particles are composed of 2 to 35 primary particles on average.

23. The particulate electrode active material according to claim 21, wherein specific surface area (BET) ranges from 0.1 m²/g to 1.5 m²/g, determined by nitrogen adsorption, in accordance with to DIN-ISO 9277:2003-05.

24. A cathode comprising:
(A) at least one cathode active material according to claim 21,
(B) carbon in electrically conductive form, and
(C) at least one binder.

25. An electrochemical cell comprising a cathode according to claim 24.
